(19) United States
(12) Patent Application Publication
(10) Pub. No.: US 2018/0314997 A1
(43) Pub. Date: Nov. 1, 2018

(54) APPARATUS AND METHOD TO SUPPORT A WORK BY EFFECTIVE GROUPING OF TASKS IN A WORKFLOW

(71) Applicant: FUJITSU LIMITED, Kawasaki-shi (JP)

(72) Inventors: Masahide NODA, Kawasaki (JP); Junichi Yura, Kawasaki (JP); Tatsuro Matsumoto, Yokohama (JP)

(73) Assignee: FUJITSU LIMITED, Kawasaki-shi (JP)

(21) Appl. No.: 15/957,980

(22) Filed: Apr. 20, 2018

(30) Foreign Application Priority Data
Apr. 27, 2017 (JP) 2017-088151

(51) Int. Cl. G06Q 10/06

(52) U.S. Cl. CPC G06Q 10/06311; G06F 3/04847

(57) ABSTRACT

An information processing device groups a plurality of tasks included in a workflow into a plurality of groups, based on whether sensor information obtained from a value detected by a sensor satisfies an execution requirement which is set for one or more tasks among the plurality of tasks and defines whether the one or more tasks are to be executed. The information processing device generates display information that is to be used to display the plurality of tasks in association with the plurality of groups, and outputs the generated display information. A terminal displays, on a display screen, the plurality of tasks in association with the plurality of groups, based on the display information received from the information processing device.

### CROSS-REFERENCE TO RELATED APPLICATION

This application is based upon and claims the benefit of priority of the prior Japanese Patent Application No. 2017-88151, filed on Apr. 27, 2017, the entire contents of which are incorporated herein by reference.

### FIELD

The embodiments discussed herein are related to apparatus and method to support a work by effective grouping of tasks in a workflow.

### BACKGROUND

For example, companies that provide IT-related, electronic, and electric services provide maintenance services for maintaining and inspecting facilities and the like of companies. In the maintenance services, workers execute maintenance work such as maintenance, fine adjustment, test operations, regular inspection, and the like of devices and systems, for example. Advanced technical knowledge may be requested for the maintenance work, for example. Thus, it may take time to develop human resources, and there are concerns about shortages of human resources. For example, a work support technique for supporting work (tasks) that is maintenance work and the like and to be executed in a series of procedures has been developed.

In the work support technique, tasks to be executed in a series of procedures are described as a flow, for example. A terminal supports work by presenting, to a worker, details of a task to be executed next in accordance with the flow, for example.

Examples of related art are Japanese Laid-open Patent Publications Nos. 10-275188, 2008-171423, and 5-143610.

### SUMMARY

According to an aspect of the invention, an apparatus groups a plurality of tasks included in a workflow into a plurality of groups, based on whether sensor information obtained from a value detected by a sensor satisfies an execution requirement which is set for one or more tasks among the plurality of tasks and defines whether the one or more tasks are to be executed. The apparatus generates display information that is to be used to display the plurality of tasks in association with the plurality of groups, to output the generated display information. A terminal displays, on a display screen, the plurality of tasks in association with the plurality of groups, based on the display information received from the apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B, and 1C are diagrams describing exemplary work support;

FIG. 2 is a diagram illustrating an exemplary work support system;

FIG. 3 is a diagram exemplifying a block configuration of an information processing device according to an embodiment;

FIG. 4 is a diagram exemplifying a block configuration of a terminal according to the embodiment;

FIGS. 5A and 5B are diagrams exemplifying the grouping of multiple tasks included in a flow according to the embodiment;

FIG. 6 is another diagram exemplifying the grouping of the multiple tasks included in the flow according to the embodiment;

FIG. 7 is a diagram exemplifying task execution state information according to the embodiment;

FIGS. 8A and 8B are diagrams exemplifying flow information and the flow according to the embodiment;

FIG. 9 is a diagram exemplifying real-world state information according to the embodiment;

FIG. 10 is a diagram exemplifying an operational flow of a process, to be executed by a controller of the information processing device, of outputting display information;

FIG. 11 is a diagram exemplifying an operational flow of a grouping process to be executed by the controller of the information processing device;

FIGS. 12A and 12B are diagrams exemplifying display information obtained from the results of the grouping process according to the embodiment;

FIG. 13 is a diagram exemplifying an operational flow of a process, to be executed by a controller of the terminal according to the embodiment, of displaying a display screen for work support;

FIG. 14 is a diagram exemplifying the display screen for the work support;

FIGS. 15A and 15B are diagrams exemplifying flow structures of branches according to the embodiment;

FIGS. 16A and 16B are diagrams exemplifying the expansion and display of a group; and

FIG. 17 is a diagram exemplifying a hardware configuration of a computer.

### DESCRIPTION OF EMBODIMENTS

A procedure of the flow that is presented to the worker, however, has been determined by a designer of the flow or the like, for example. Thus, situations in which the worker executes the work and the like may not be considered, and the worker may not easily execute the work in accordance with the presented procedure.

It is desirable to provide a technique for presenting a flow procedure based on a situation or the like upon the execution of work.

Hereinafter, embodiments are described in detail with reference to the accompanying drawings. Elements illustrated in multiple drawings and corresponding to each other are indicated by the same reference symbol.

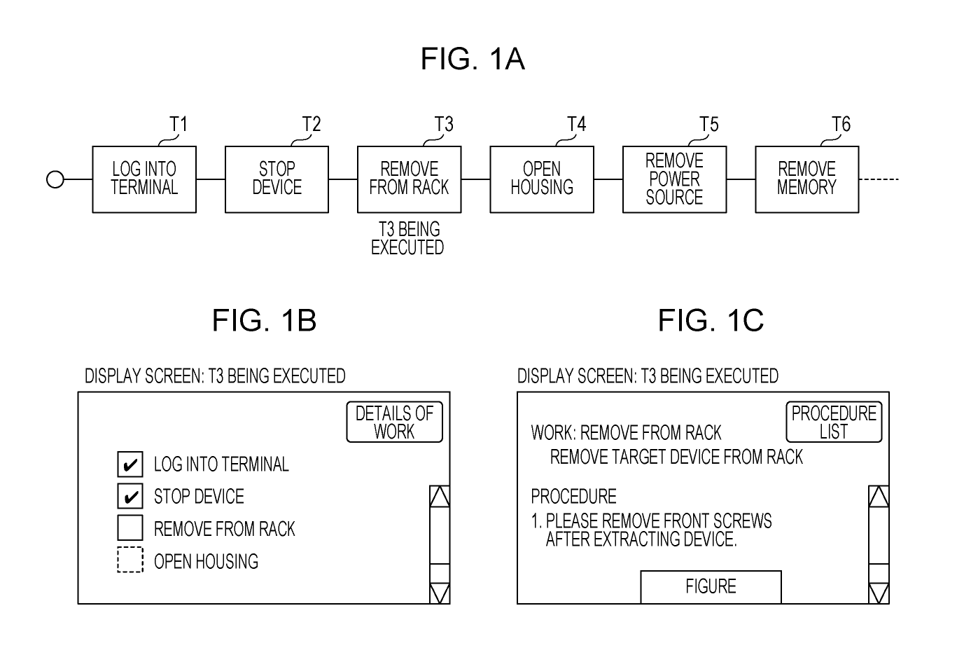

FIGS. 1A, 1B, and 1C are diagrams describing exemplary work support. In an example illustrated in FIGS. 1A, 1B, and 1C, a terminal carried by a worker displays details of multiple tasks to be executed and supports work of the worker based on execution states of the multiple tasks included in a flow. FIG. 1A exemplifies the flow to be executed by the worker and illustrates tasks T1 to T6. FIG. 1B exemplifies a display screen of the terminal carried by the worker and illustrates that the tasks T1 to T4 are displayed. The display screen illustrated in FIG. 1B indicates that the task T1 of logging into the terminal and the task T2 of stopping a device are already checked on the display screen illustrated in FIG. 1B and are already completed by the worker. The worker may know that the next task is the task T3 of removing from a rack. The task T4 of opening a housing may be executed after the execution of the task T3 and has yet to be executed in a state illustrated in FIG. 1B and is indicated by a broken line in FIG. 1B. The worker may operate the terminal to open details of the task T3 of removing from the rack and display a display screen illustrated in FIG. 1C in the terminal to confirm how to execute the work in detail. In the aforementioned manner, the work for which the worker is responsible may be supported, for example.

It is considered that the tasks of the flow may be grouped and presented to the worker for each of groups, for example. The worker may easily recognize the groups of the work by the grouping, for example. For example, if the tasks are to be grouped, a designer of the flow or the like sets the groups, and the setting may cause a burden to the designer. If the person who groups the tasks is different from the worker who executes the work on a target site, the grouping may not be suitable for the worker. If the groups are determined in advance, the grouping is fixed, and the state of the work is not reflected in the grouping. As a result, a procedure for executing the work may not be suitable for the worker. It is, therefore, desirable to provide a technique for appropriately grouping the tasks of the flow, based on the state of the worker and the state of the work upon the execution of the work and presenting a procedure for the work. An embodiment is described below.

### Embodiment

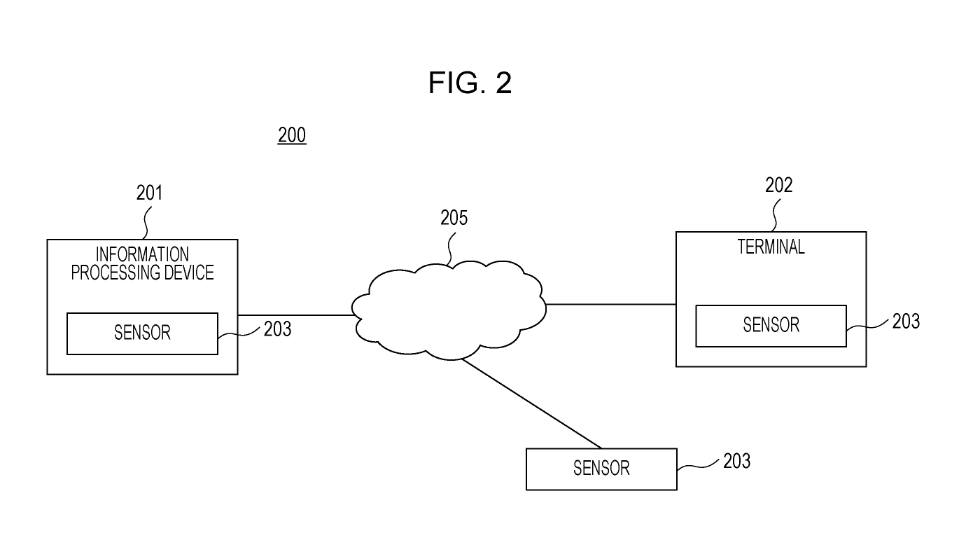

FIG. 2 is a diagram illustrating an exemplary work support system 200. The work support system 200 includes an information processing device 201, a terminal 202, and a sensor 203, for example. The information processing device 201, the terminal 202, and the sensor 203 may be coupled to and communicate with each other via a network 205, for example. Alternatively, sensors 203 may be included in the information processing device 201 and the terminal 202. The information processing device 201 may be a computer such as a server. The terminal 202 may be a smartphone, a mobile phone, a tablet terminal, or the like, for example. The terminal 202 is carried by a worker and supports work to be executed by the worker, for example. The information processing device 201 notifies, to the terminal 202, based on the flow indicating a procedure for the work, display information to be used to support the work to be executed by the worker and causes the terminal 202 to display a display screen for supporting the work, for example. The sensor 203 may be configured to detect real-world information described later, for example. The sensors 203 may be included in the information processing device 201 and the terminal 202, depending on real-world information to be acquired, and the sensor 203 may be separated from the information processing device 201 and the terminal 202, depending on real-world information to be acquired, for example.

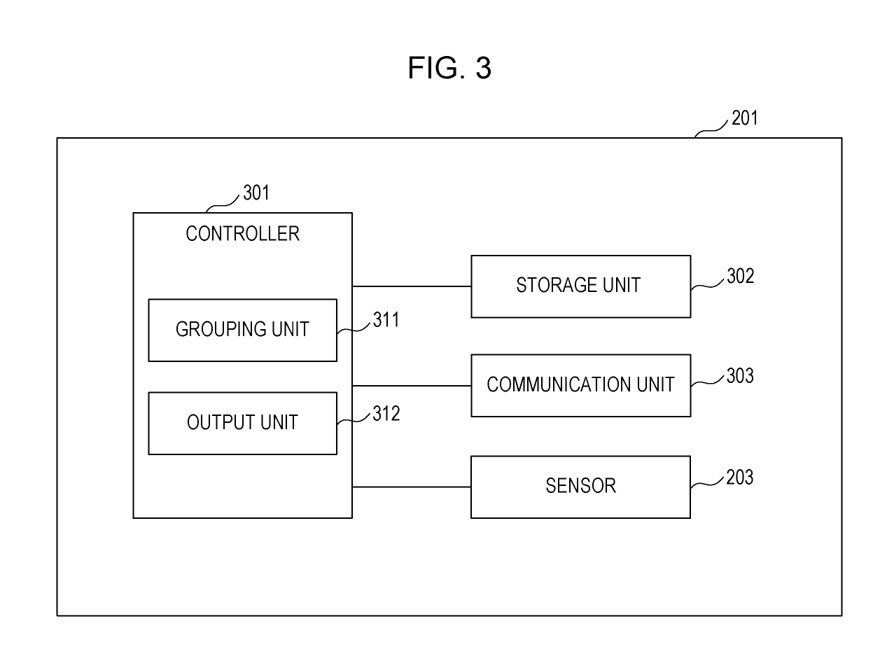

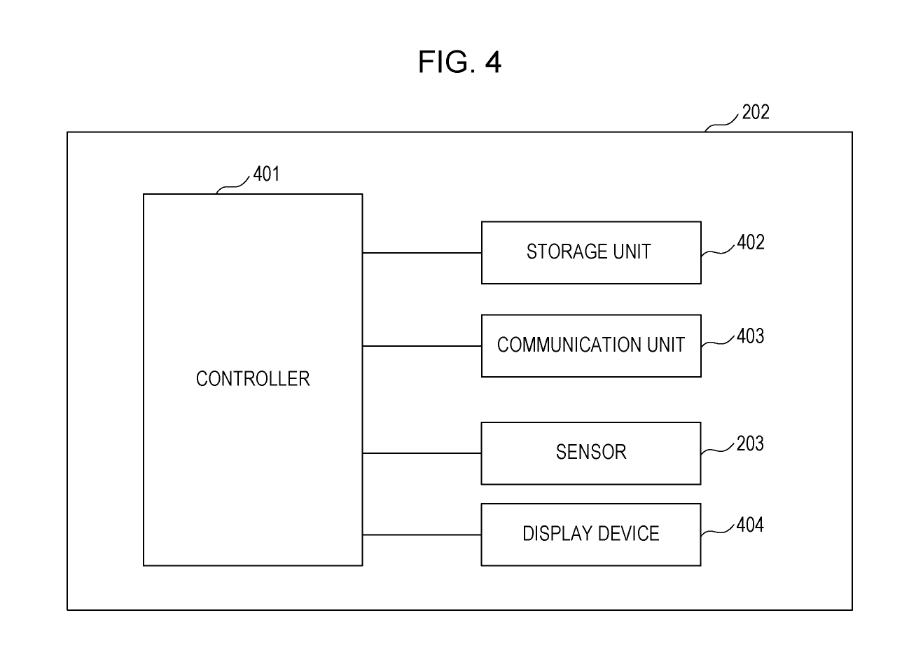

FIG. 3 is a diagram exemplifying a block configuration of the information processing device 201 according to the embodiment. The information processing device 201 includes a controller 301, a storage unit 302, and a communication unit 303, for example. In addition, the information processing device 201 may include the sensor 203. The controller 301 operates as a grouping unit 311, an output unit 312, and the like, for example. The storage unit 302 stores information including task execution state information 700, flow information 800, and real-world state information 900, for example. The communication unit 303 communicates with the terminal 202 and the external sensor 203 via the network 205 in accordance with an instruction from the controller 301, for example. The sensor 203 may be configured to detect real-world information, for example. Details of these units and details of the information stored in the storage unit 302 are described later.

FIG. 14 is a diagram exemplifying a block configuration of the terminal 202 according to the embodiment. The terminal 202 includes a controller 401, a storage unit 402, a communication unit 403, and a display device 404, for example. In addition, the terminal 202 may include the sensor 203, for example. The storage unit 402 stores information including the task execution state information 700 described later and the flow information 800 described later, for example. The sensor 203 may be configured to detect real-world information, for example. The communication unit 403 communicates with the information processing device 201 and the external sensor 203 via the network 205 in accordance with an instruction from the controller 401, for example. Details of the units and details of the information stored in the storage unit 402 are described later.

Next, a process of supporting the work according to the embodiment is described. In the embodiment described below, the controller 301 of the information processing device 201 executes grouping based on whether real-world information detected by the sensor 203 satisfies an execution requirement set for one or more tasks included in the flow, for example. The execution requirement may be set for information obtained from a value detected by the sensor 203 installed in the real world and may define whether or not the one or more tasks for which the execution requirement has been set are to be executed, for example. The sensor 203 may sense a physical effect or sense a predetermined state from information abstracted by the work support system 200 based on the physical effect.

The execution requirement may be set for a date and time when the work is executed, a location at which the work is executed, a human behavior, a person with which the worker stays, vital information of the worker, or the like as an example. For example, it is assumed that the execution requirement set for the one or more tasks indicates a date and time after 17:00 on Jan. 13, 2017. In this case, for example, if time acquired from the sensor 203 (for example, a clock) is before 17:00 on Jan. 13, 2017, the execution requirement is not satisfied and the one or more tasks are not executed.

In addition, for example, it is assumed that the execution requirement indicates a location that is a server room set as a location where the one or more tasks are executed. In this case, if a location that has been acquired from the sensor 203 and at which the worker stays is not the server room, the execution requirement is not satisfied and the one or more tasks are not executed.

When the execution requirement indicates a location, the sensor 203 may be any of various devices configured to identify a location. For example, the sensor 203 may be a global positioning system (GPS) device. In this case, the controller 401 of the terminal 202 notifies a position measured by the GPS device to the information processing device 201. Then, the controller 301 of the information processing device 201 may determine that the worker stays at the location specified in the execution requirement when the notified position is in a predetermined region defined by a latitude and a longitude. When the sensor 203 is a wireless local area network (LAN) communication device installed in the terminal 202, the controller 401 of the terminal 202 notifies the intensity, measured by the sensor 203, of a radio wave including a predetermined service set identifier (SSID) to the information processing device 201. Then, when the notified intensity of the radio wave is equal to or higher than a predetermined threshold, the controller 301 of the information processing device 201 may determine that the worker stays at the location specified in the execution requirement. Alternatively, as another example, when an entry and exit management system is used to manage entries and exits into and from a room by reading identifier (ID) cards or the like, the entry and exit management system may operate as the sensor 203. In this case, when the entry and exit management system detects that the worker stays in the room, the entry and exit management system may notify the information processing device 201 that the worker stays in the room. Then, when the information processing device 201 receives the notification from the entry and exit management system, the controller 301 of the information processing device 201 may determine that the worker stays at the location specified in the execution requirement.

In addition, the execution requirement may be set for a behavior (for example, walking, running, or the like) of the person, for example. In this case, when an integrated value of acceleration detected by the sensor 203, which is installed in the terminal 202 and is an acceleration sensor or the like, during a past predetermined time period is in a predetermined range, the controller 401 of the terminal 202 determines that the worker is walking or running. Then, the terminal 202 may notify the detected state of the worker to the information processing device 201. The controller 301 of the information processing device 201 may determine, based on the received notification, whether or not the one or more tasks are to be executed.

In addition, the information processing device 201 may acquire information indicating a person staying with the worker from information entered by the worker since the terminal 202 has prompted the worker to enter the information, or the information processing device 201 may identify the person staying with the worker by acquiring information via near-field wireless communication between the terminal 202 and a terminal carried by the other person staying near the worker, for example. Alternatively, the information processing device 201 may acquire vital information of the worker from a vital sensor worn by the worker, for example.

Then, the controller 301 of the information processing device 201 groups multiple tasks included in the flow based on the execution requirement. For example, upon reading the flow, the controller 301 of the information processing device 201 according to the embodiment may dynamically generate a group based on the structure of the flow, an execution requirement defined in the flow, an execution state of the flow, and a real-world state (real-world information) detected by the sensor. For example, the controller 301 of the information processing device 201 may group, into different groups, tasks between which an execution requirement is changed. Specifically, for example, the controller 301 may group a certain task for which an execution requirement has been set and a task to be executed immediately before the certain task into different groups, respectively. In addition, when an execution requirement set for a certain task is already satisfied, the controller 301 may group the certain task into a group to which a task to be executed immediately before the certain task belongs. For example, when a real-world state or the execution state of the flow changes, the controller 301 of the information processing device 201 may regenerate a group.

In addition, as another execution requirement, an execution requirement for setting groups so that a certain group is separated from the other groups may be set. For example, it is assumed that, in the case where an execution requirement for starting maintenance work at 2:00 is already set, the maintenance work has been started after 2:00 due to a delay of the preparation of maintenance. Since details of the maintenance work are significantly different from details of work of preparing the maintenance, an execution requirement for separating a group of the maintenance work from a group of the preparation work may be set for the last task of the preparation work. The execution requirement for separating groups from each other is referred to as second execution requirement in some cases, for example. The grouping is described below in more detail.

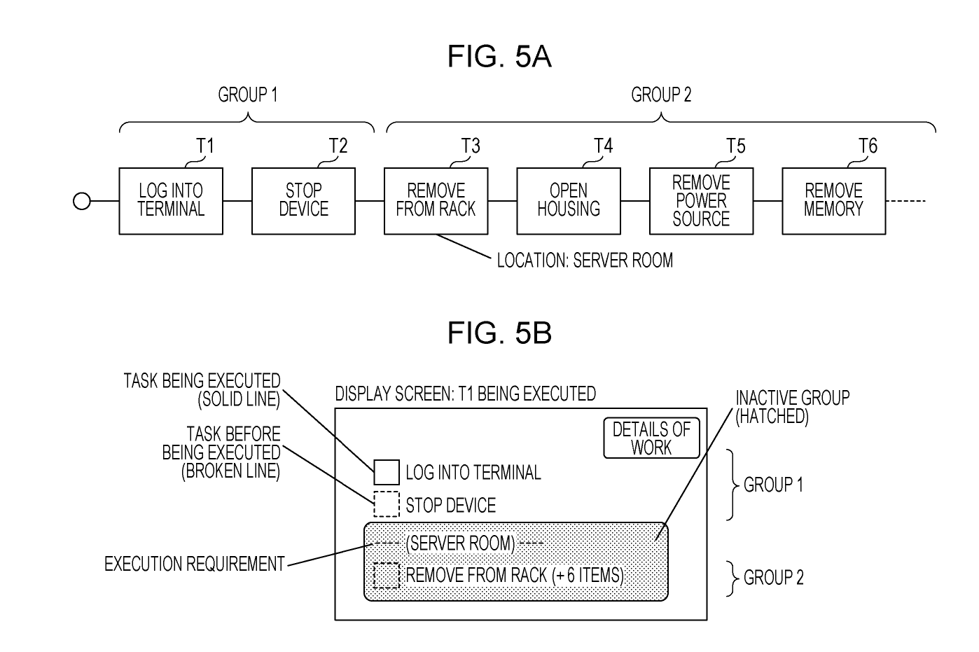

FIGS. 5A and 5B are diagrams exemplifying the grouping of multiple tasks included in the flow according to the embodiment. For example, FIG. 5A exemplifies the flow to be executed by the worker and illustrates tasks T1 to T6. In addition, the server room as a location is set as an execution requirement for the task T3 of removing from the rack. FIG. 5A indicates that the task T3 of removing from the rack is executed after the terminal 202 is moved into the server room. Specifically, in the example illustrated in FIG. 5A, the worker may execute the tasks T1 and T2 at any location, but the worker executes the tasks T3 and later in the server room after moving into the server room, and an execution requirement is changed to the execution requirement set for the task T3 at a boundary between the task T2 and the task T3. Thus, the information processing device 201 may group the tasks T1 and T2 into a group 1 and group the tasks T3 to T6 into a group 2.

In addition, FIG. 5B is a diagram exemplifying the display screen for supporting the work for the worker based on the grouping described with reference to FIG. 5A. In an example illustrated in FIG. 5B, all the tasks have yet to be completed, and the task T1 of logging into the terminal is displayed as a task being executed (and a checkbox for the task T1 is displayed by a solid line). Since the task T1 has yet to be completed, the task T2 of stopping the device is not displayed as a task being executed and is displayed as a task before being executed (and a checkbox for the task T2 is displayed by a broken line). In addition, since the worker does not stay in the server room, the tasks T3 and later of the group 2 are not executed and are organized as an inactive group and displayed by hatching. The execution requirement that causes the grouping may be displayed on the display screen for the work support so that the worker knows what to do in order to satisfy the execution requirement and execute the next work.

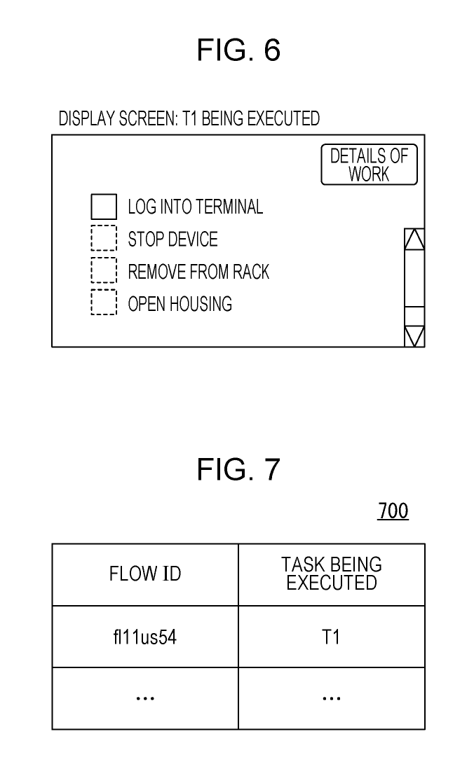

For example, when the worker moves into the server room, the execution requirement, which indicates the server room and causes the grouping of the tasks into the group 1 and the group 2, is satisfied. In this case, the controller 301 of the information processing device 201 may combine the group 1 and the group 2 into a single group and cause the terminal 202 to display the single group on the display screen. In this case, a display screen illustrated in FIG. 6 may be displayed on a display screen of the display device 404 of the terminal 202, for example.

As described above, according to the embodiment, multiple tasks that are included in the flow are separated from each other at a boundary where an execution requirement is changed and are displayed for each of groups together with the execution requirement. For example, in the case where an execution requirement is changed, the execution requirement is treated as a boundary, and tasks that are to be executed before the execution requirement is changed are already completed in many cases. By grouping tasks into groups at the boundary where the execution requirement is changed, the worker may easily plan the work. In addition, by displaying an execution requirement on the display screen, the worker may easily recognize work that is able to be executed by the worker in the current state of the worker, work that is not able to be executed by the worker in the current state of the worker, and how to execute succeeding work in the current state of the worker. In addition, in the embodiment, when an execution requirement is satisfied, a certain group for which the execution requirement has been set is combined with a group to be executed immediately before the certain group. By dynamically determining the grouping based on the state of the work or the like, the display screen for supporting the work, which enables the worker to easily execute the work, may be presented. The embodiment is described in detail below.

FIG. 7 is a diagram exemplifying the task execution state information 700 according to the embodiment. The task execution state information 700 may be stored in the storage unit 302 of the information processing device 201 and the storage unit 402 of the terminal 202, for example. In the task execution state information 700, a flow ID that identifies the flow executed by the terminal 202, and a task that is being executed by the worker using the terminal 202 in the flow identified by the flow ID, are associated with each other and registered, for example. For example, it is assumed that the worker manipulates a checkbox or the like on the display screen to input a signal indicating that a task has been completed. After that, the controller 401 of the terminal 202 may change, to a next task, the task being executed that has been registered in an entry of the task execution state information 700 including the flow ID of the flow for which information indicating the completion of the task has been input. In addition, the controller 401 of the terminal 202 may notify, to the information processing device 201, an execution state update request indicating the flow for which the information indicating the completion of the task has been input. Upon receiving the execution state update request, the information processing device 201 may change, to the next task, the task being executed that has been registered in the entry of the task execution state information 700 including the flow ID of the flow indicated in the execution state update request.

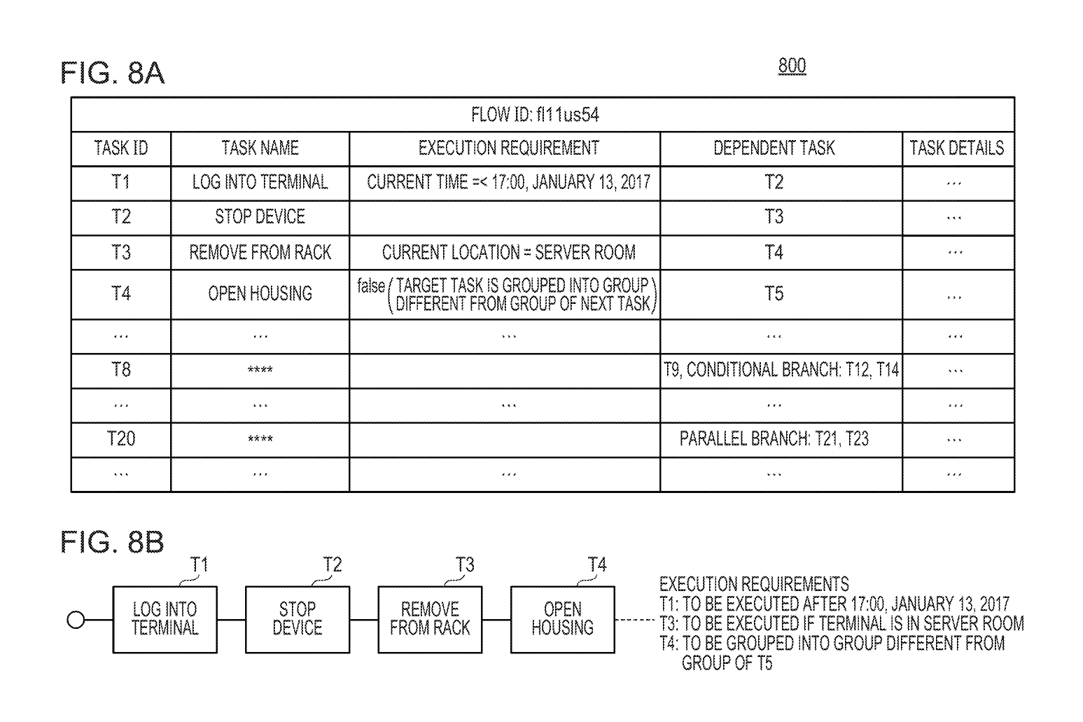

FIG. 8A is a diagram exemplifying the flow information 800 according to the embodiment, and FIG. 8B is a diagram exemplifying the flow. In the flow information 800 illustrated in FIG. 8A, entries related to the flow identified by the flow ID are registered. In the entries, task IDs, task names, execution requirements, dependent tasks, and task details are associated with each other and registered. In the flow information 800, the entries may be registered in the order based on a procedure for the flow as an example. The task IDs are identifiers identifying tasks. The task names are assigned to the tasks identified by the task IDs registered in the entries. In an execution requirement item of the flow information 800, the execution requirements to be used to determine whether or not the tasks identified by the task IDs registered in the entries are to be executed are registered. An execution requirement indicating false and set for the task ID T4 illustrated in FIG. 8A defines that the target task T4 is grouped into a group different from a group to which the next task (having the task ID T5) belongs. The dependent tasks are information that specifies tasks to be executed immediately after the tasks registered in the entries and defines the structure of the flow. In a dependent task item of the flow information 800, information indicating a conditional branch described later and information indicating a parallel branch described later may be registered. In a task details item of the flow information 800, information indicating task details exemplified in FIG. 1C may be registered. FIG. 8B illustrates the flow defined in FIG. 8A, and the controller 301 may generate the flow from the flow information 800. The flow information 800 illustrated in FIG. 8A is an example, and the embodiment is not limited to this. For example, the flow information 800 defining the flow according to the embodiment may be generated in accordance with a format such as XPDL, BPEL, or BPMN, for example. XPDL stands for XML Process Definition Language, for example. BPEL stands for Business Process Execution Language, for example. BPMN stands for Business Process Modeling Notation, for example.

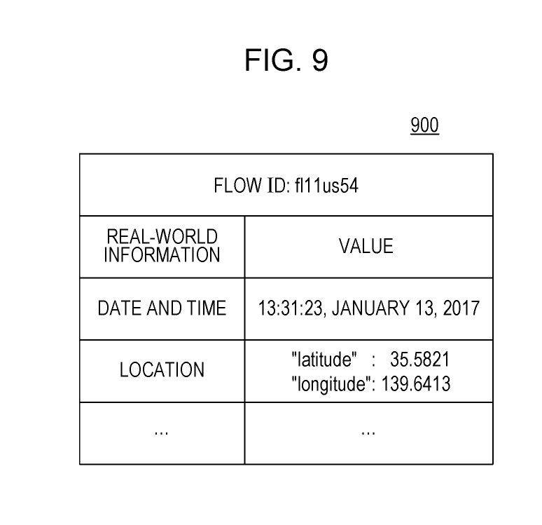

FIG. 9 is a diagram exemplifying the real-world state information 900 according to the embodiment. In the real-world state information 900, current values of real-world information associated with execution requirements set in the flow identified by the flow ID are registered, for example. For example, every time a value of real-world information detected by the sensor 203 is updated, the sensor 203 or the terminal 202 including the sensor 203 may notify a request, including the updated real-world information, to update a real-world state to the information processing device 201. For example, upon receiving the request to update the real-world state, the information processing device 201 updates a value registered in an entry of the real-world state information 900 to the value of the real-world information included in the request to update the real-world state. For example, when the real-world information indicates a location, the controller 301 of the information processing device 201 updates the real-world state information 900 so that the real-world information is updated to information indicating the current position of the terminal 202, which is included in a real-world state update request notified by the terminal 202 at each of predetermined time intervals. When the real-world information indicates a date and time, the controller 301 of the information processing device 201 may use a clock included in the information processing device 201 as the sensor 203 to acquire current time.

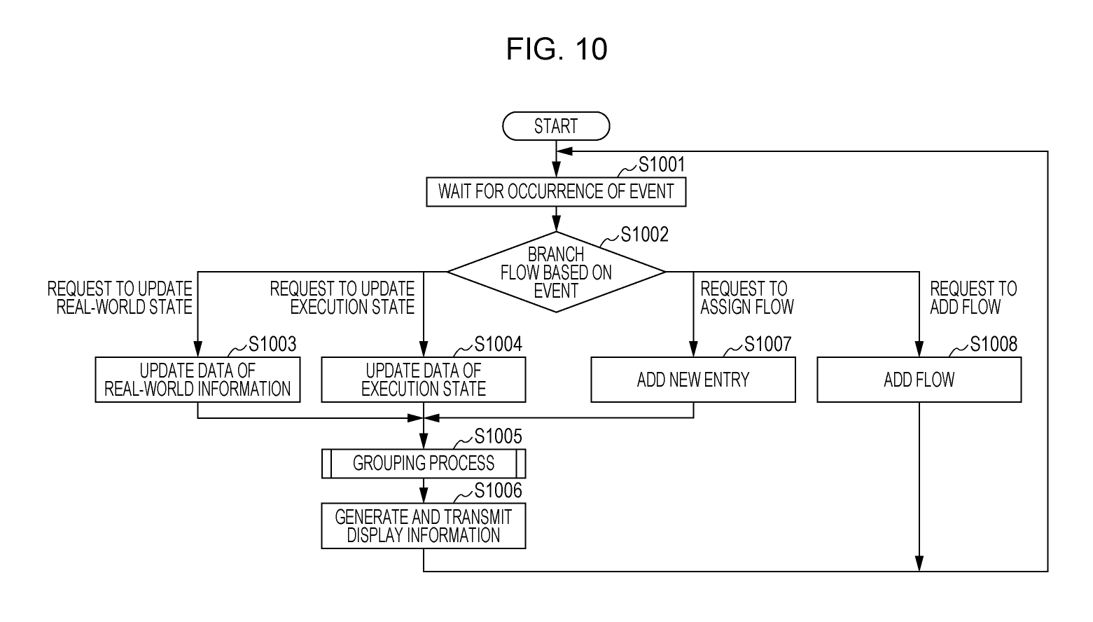

FIG. 10 is a diagram exemplifying an operational flow of a process, to be executed by the controller 301 of the information processing device 201, of outputting display information. When an instruction to execute the work support for the terminal 202 carried by the worker is input to the information processing device 201, the controller 301 of the information processing device 201 may start the process, illustrated in FIG. 10, of outputting the display information.

In step 1001 (step is hereinafter expressed by S, and, for example, step 1001 is hereinafter expressed by S1001), the controller 301 of the information processing device 201 waits for the occurrence of an event. In S1002, the controller 301 branches the operational flow based on the event that has occurred, where the event may be the input of a request from the terminal 202, the sensor 203, or another device.

For example, when a request to update real-world information is input from the terminal 202 or the sensor 203 to the information processing device 201, the controller 301 of the information processing device 201 causes the flow to proceed to S1003 in S1002. In S1003, the controller 301 registers, in the real-world state information 900, the real-world information included in the request to update the real-world information and updates the real-world information. Then, the flow proceeds to S1005.

In addition, for example, when a request to update the execution state of the flow is input from the terminal 202 to the information processing device 201 in S1001, the controller 301 of the information processing device 201 causes the flow to proceed to S1004 in S1002. The request to update the execution state includes the flow ID identifying the flow whose execution state is to be updated and information of a task being executed, which indicates a task that is currently being executed in the terminal 202 from which the request to update the execution state has been input, for example. Then, in S1004, the controller 301 updates, to the task that is being executed and is included in the request to update the execution state, a task being executed that has been registered in an entry included in the task execution state information 700 and including the flow ID included in the request to update the execution state. Then, the flow proceeds to S1005.

When a request to assign a new flow is input from the terminal 202 to the information processing device 201 in S1001, the controller 301 of the information processing device 201 causes the flow to proceed to S1007 in S1002. In S1007, the controller 301 registers an entry including a flow ID of the flow requested to be assigned in the task execution state information 700. Then, the flow proceeds to S1005. A task being executed that is indicated in the registered entry may be set at a first task of the flow which is positioned at a head of the flow.

When a request to add a new flow is input from the terminal 202 or another device to the information processing device 201 in S1002, the controller 301 of the information processing device 201 causes the flow to proceed to S1008 in S1002. In S1008, the controller 301 assigns a flow ID to the flow instructed to be added in accordance with the request to add the flow, generates the flow information 800, and causes the generated flow information 800 to be stored in the storage unit 302. Then, the flow returns to S1001.

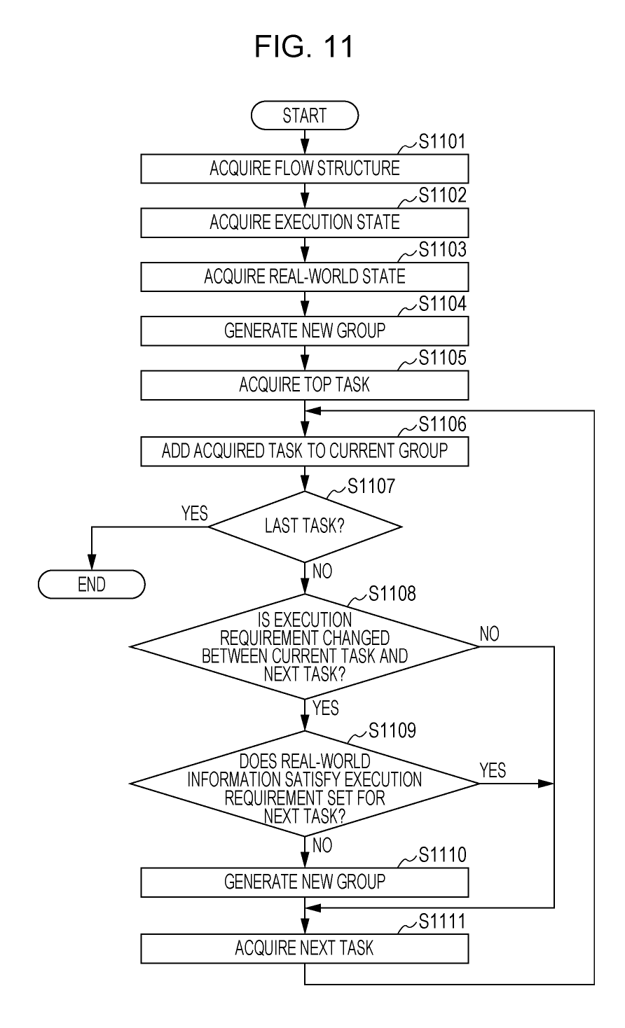

In S1005, the controller 301 generates a group for the flow that is to be processed and for which a request such as the request to update the real-world information, the request to update the execution state, or the request to assign the flow has been notified. For example, the controller 301 executes an operational flow illustrated in FIG. 11 and described later and groups multiple tasks included in the flow to be processed into groups based on the real-world information and an execution requirement.

In S1006, the controller 301 generates display information based on the grouping. Then, the controller 301 transmits the generated display information to the terminal 202 executing the work support on the flow that is to be processed and for which the request such as the request to update the real-world information, the request to update the execution state, or the request to assign the flow has been notified. Then, the flow returns to S1001.

In S1005 of the operational flow illustrated in FIG. 10, the controller 301 of the information processing device 201 operates as the grouping unit 311, for example. In addition, in S1006, the controller 301 of the information processing device 201 operates as the output unit 312, for example.

Next, a grouping process according to the embodiment is described with reference to FIG. 11. FIG. 11 is a diagram exemplifying the operational flow of the grouping process to be executed by the controller 301 of the information processing device 201. For example, when the flow proceeds to S1005 illustrated in FIG. 10, the controller 301 of the information processing device 201 may start the grouping process illustrated in FIG. 11.

In S1101, the controller 301 reads the flow information 800 of the flow to be processed in S1003, S1004, or S1007, which is a calling process of the process of S1005, and acquires the structure of the flow based on the flow information 800. The flow to be processed in S1003, S1004, or S1007, which is a calling process of the process of S1005, is hereinafter referred to as the flow to be processed in some cases.

In S1102, the controller 301 references an entry that includes the flow ID of the flow to be processed and is included in the task execution state information 700, thereby acquiring a task being executed.

In S1103, the controller 301 acquires real-world information by referencing the real-world state information 900 identified by the flow ID of the flow to be processed. In the real-world state information 900, the latest real-world information, which is notified by the sensor 203 or the terminal 202 including the sensor 203 at a predetermined timing, may be registered.

In S1104, the controller 301 generates a group for storing the task and uses the generated group as a group targeted to store the task. In S1105, the controller 301 reads the top task from the flow information 800 of the flow to be processed. In S1106, the controller 301 adds the read task to the group generated in S1104.

In S1107, the controller 301 determines whether or not the task added to the group in S1106 is the last task indicated in the flow information 800 of the process to be processed. When the task added to the group is the last task indicated in the flow information 800 of the process to be processed (YES in S1107), the operational flow illustrated in FIG. 11 is terminated and the flow proceeds to S1006. In this case, in S1006, the controller 301 may transmit, to the terminal 202, display information including information of the grouping executed in the operational flow illustrated in FIG. 11.

When the task added to the group is not the last task indicated in the flow information 800 of the flow to be processed (NO in S1107), the flow proceeds to 51108. In S1108, the controller 301 reads a next task indicated in the flow information 800 and determines whether or not an execution requirement that is different from an execution requirement set for the current task has been set for the next task. The next task may be a task set in the dependent task item of the flow information 800, for example. When the execution requirement is not changed between the current task and the next task (NO in S1108), the flow proceeds to S1111. As an example, when an execution requirement has not been set for the next task in the flow information 800, the controller 301 may determine that the execution requirement is not changed between the current task and the next task. Then, in S1111, the controller 301 acquires the next task as a task to be processed and registers the next task in the group to which the previous task has been added in S1106.

On the other hand, when the execution requirement is changed between the current task and the next task (YES in S1108), the flow proceeds to S1109. Then, in S1109, the controller 301 determines whether or not the real-world information acquired from the real-world state information 900 satisfies the execution requirement set for the next task. For example, when the execution requirement indicates time (after 17:00), the controller 301 may determine whether the current date and time, which have been acquired from the sensor 203, such as a clock, configured to measure time, and have been registered in the real-world state information 900, are after 17:00. In addition, for example, when the execution requirement indicates the location (server room), the controller 301 may determine whether or not the terminal 202 is in the server room, based on real-world information indicating the position of the terminal 202 and acquired from the real-world state information 900.

When the real-world information acquired from the real-world state information 900 satisfies the execution requirement set for the next task (YES in S1109), the flow proceeds to S1111. In this case, although the execution requirement set for the next task is different from the execution requirement set for the current task, the execution requirement set for the next task is already satisfied, and the current task and the next task are grouped into the same group.

On the other hand, when the real-world information acquired from the real-world state information 900 does not satisfy the execution requirement for the next task (NO in S1109), the flow proceeds to S1110. In S1110, the controller 301 terminates the assignment of tasks to the current group, generates a new group, and uses the generated group as a group targeted to store tasks. Then, the flow proceeds to S1111. Specifically, in this case, since the execution requirement set for the next task is different from the execution requirement set for the current task, the execution requirement set for the next task has yet to be satisfied, and the next task is not executed, the next task is grouped into a group different from the group of the current task.

As described above, according to the operational flow illustrated in FIG. 11, since the grouping may be executed based on real-world information detected by the sensor 203 and registered in the real-world state information 900, the grouping may be executed based on the current state of the work.

In the aforementioned operational flow illustrated in FIG. 11, the controller 301 of the information processing device 201 operates as the grouping unit 311.

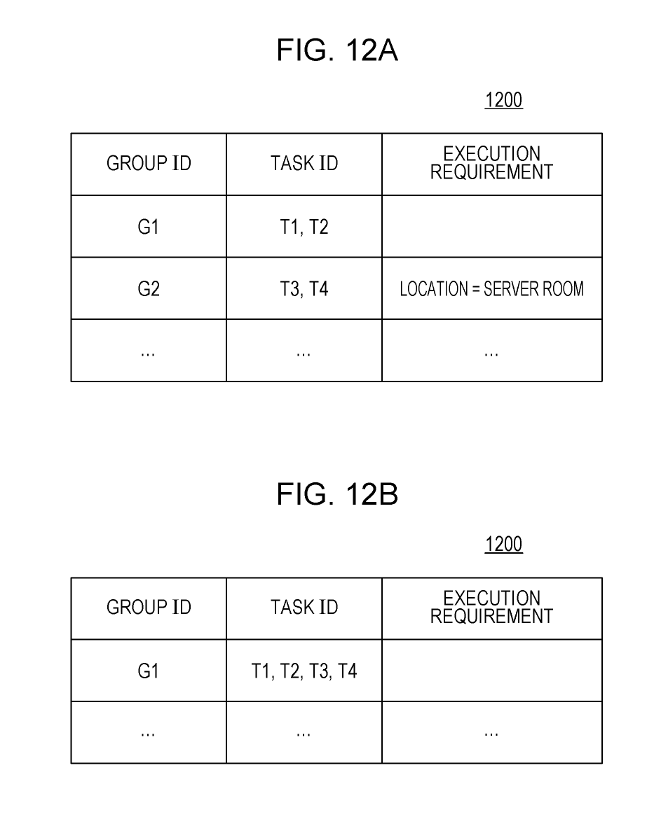

FIGS. 12A and 12B are diagrams exemplifying display information 1200 acquired from the results of the grouping process according to the embodiment. FIGS. 12A and 12B illustrate the display information 1200 for a certain flow. However, since a real-world state in which the display information 1200 illustrated in FIG. 12A is generated is different from a real-world state in which the display information 1200 illustrated in FIG. 12B is generated, groups indicated in the display information 1200 illustrated in FIG. 12A are different from groups indicated in the display information 1200 illustrated in FIG. 12B. For example, in FIG. 12A, the terminal 202 carried by the worker is not located in the server room when the display information 1200 is generated, the execution requirement that has been set for the tasks T3 and T4 and indicates the location or the server room is not satisfied. As a result, the tasks T3 and T4 are grouped into to a group G2 different from the group G1 of the tasks T1 and T2.

On the other hand, in FIG. 12B, since the terminal 202 carried by the worker is located in the server room when the display information 1200 is generated, the execution requirement that has been set for the tasks T3 and T4 and indicates the location or the server room is satisfied. As a result, the tasks T1, T2, T3, and T4 are grouped into the single group G1. In this manner, the grouping may be executed based on the real-world state. A task to be executed may be appropriately grouped based on the current state of the worker and the like. Thus, the information processing device 201 may execute the work support so that the work support is convenient for the worker.

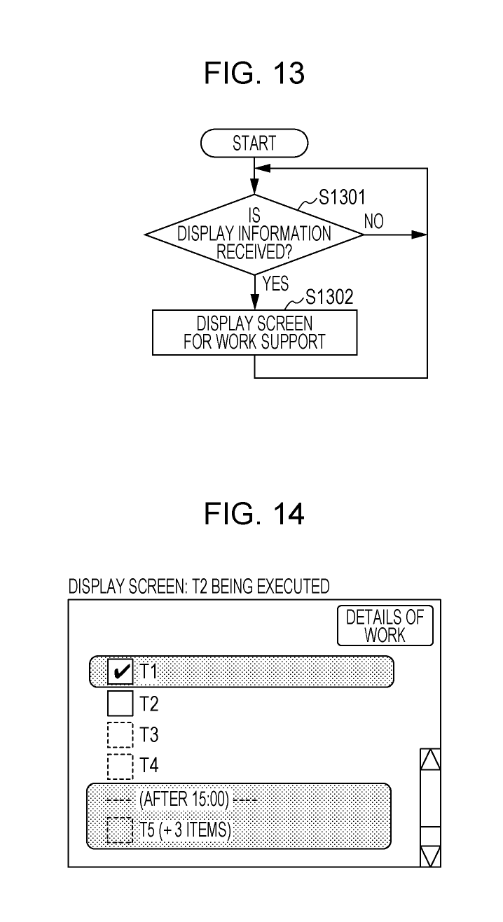

Next, a process of displaying the display screen for the work support in the terminal 202 is described. FIG. 13 is a diagram exemplifying an operational flow of the process, to be executed by the controller 401 of the terminal 202 according to the embodiment, of displaying the display screen for the work support. For example, when an instruction to display the display screen for the work support is input to the terminal 202, the controller 401 of the terminal 202 may start the operational flow illustrated in FIG. 13.

In S1301, the controller 401 determines whether or not the terminal 202 has received the display information 1200 from the information processing device 201. When the terminal 202 has not received the display information 1200 (NO in S1301), the flow repeats the process of S1301. On the other hand, when the terminal 202 has received the display information 1200 (YES in S1301), the flow proceeds to S1302. In S1302, the controller 401 displays the display screen for the work support based on the received display information 1200. For example, the controller 401 displays the display screen for the work support so that tasks included in a group including a task being executed are individually displayed and that tasks included in groups preceding and succeeding the group including the task being executed are displayed collectively as the groups. In addition, for example, when an execution requirement is set between a first group including the task being executed and a second group immediately succeeding the first group, the controller 401 may display the display screen for the work support so that the execution requirement is displayed between the first group and the second group. When the display screen for the work support is displayed, the flow returns to S1301 and repeats the process. FIG. 14 illustrates an example of the display screen for the work support.

FIG. 14 is a diagram exemplifying the display screen for the work support. In the display screen illustrated in FIG. 14 for the work support, tasks are grouped into groups, and tasks included in a first group including the task T2 that is being executed are individually displayed. In addition, in the example illustrated in FIG. 14, a checkbox for the task T2 that is being executed is indicated by a solid line, and the worker may recognize that the task T2 is being executed. Checkboxes for the tasks T3 and T4 that belong to the same group as that of the task T2 being executed and are not executed unless the task T2 is completed are indicated by broken lines, and the worker recognizes that the tasks T3 and T4 are not to be executed.

Tasks included in the other groups preceding and succeeding the first group including the task being executed are organized and a single representative task that represents each of the other groups is displayed. As an example, a representative task of each of the groups may be a task that is among tasks of each group and to be executed at a time closest to the execution time of the task T2 that is being executed. When the display screen is displayed in this manner, works related to the task executed by the worker is displayed as tasks organized in the first group, and the worker may easily recognize details of the work. Since the tasks of the groups other than the first group including the task being executed by the worker are organized and displayed as the groups, the worker may easily plan the entire work. In addition, in the example illustrated in FIG. 14, the controller 401 displays an execution requirement indicating time after 15:00 between the first group including the task being executed and a next group. Thus, the worker may recognize what to do in order to start the next work. According to the embodiment, the worker may easily recognize a plan for the work while receiving, from the terminal 202, the support for the work being executed by the worker.

As described in the embodiment, grouping tasks and displaying the tasks as groups save a display region and are convenient in a case where the terminal 202 is a smartphone having a small display screen or the like and the worker confirms the tasks by using the terminal 202.

In the aforementioned embodiment, the controller 301 of the information processing device 201 may execute the grouping based on the structure of the flow, for example. As examples of the structure of the flow, branch structures such as a conditional branch and a parallel branch are known. The conditional branch is a branch in which any of processes is selected conditionally and executed. The parallel branch is a branch in which two or more branched processes are executed.

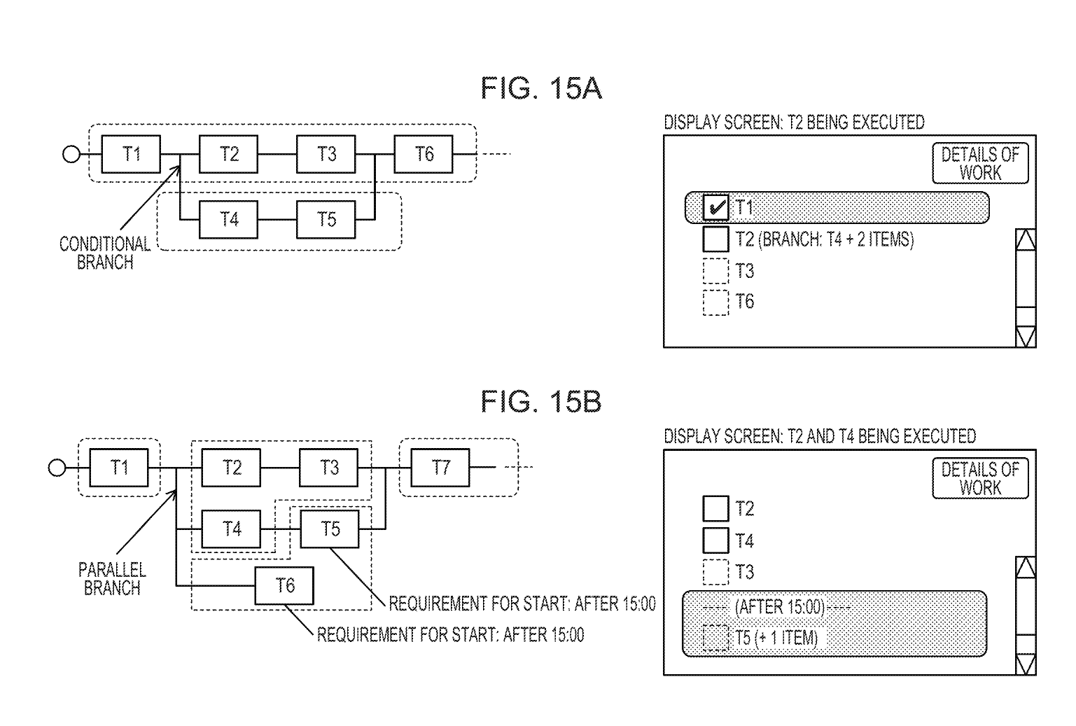

FIGS. 15A and 15B are diagrams exemplifying the flow structures of the branches according to the embodiment. FIG. 15A exemplifies the structure of an operational flow of the conditional branch. For example, in the conditional branch, the controller 301 of the information processing device 201 may execute the grouping so that tasks corresponding to processes, which are included in a second path that is not a first path defined in advance and is from a certain branched process to a process joined to a process included in the first path defined in advance, are grouped into a single group, as illustrated in FIG. 15A. In this case, the controller 301 of the information processing device 201 may execute the processes described in the aforementioned embodiment on the defined path while storing tasks corresponding to branched processes in association with a task corresponding to the process branching the flow, as a group, in the display information 1200. In addition, in the case where the conditional branch is included in the display information 1200, the controller 401 of the terminal 202 may add information on the group conditionally branched from the defined path to the task corresponding to the process branching the flow, and display the information, as indicated in the display screen illustrated in FIG. 15A.

FIG. 15B exemplifies the structure of the flow of the parallel branch. For example, in the parallel branch, the controller 301 may execute the grouping so that tasks that are included in all paths from branched processes to processes joined to a process included in a path defined in advance and for which the same execution requirement has been set are grouped into a single group, as indicated in FIG. 15B. Then, the controller 301 of the information processing device 201 may generate the display information 1200 while treating, as the next task, a single set (for example, the tasks T2 and T4 illustrated in FIG. 15B) of multiple tasks that are able to be simultaneously executed and for which the same requirement has been set in the aforementioned processes S1108 and later. In addition, in the case where the parallel branch is included in the display information, the controller 401 of the terminal 202 may display, on the display screen for the work support, the multiple tasks (T2 and T4) belonging to the same group in the parallel branch as tasks that are able to be executed, like the display screen illustrated in FIG. 15B, for example.

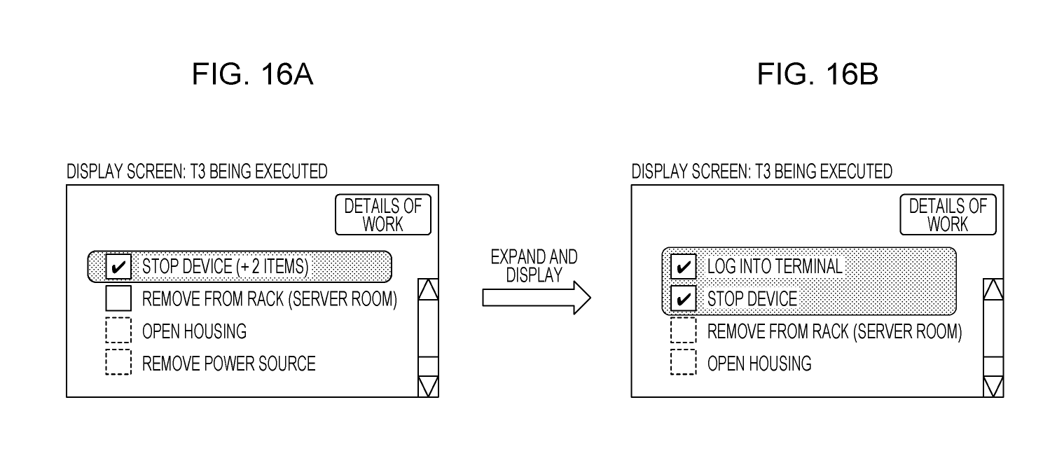

The embodiment describes the example in which the representative tasks are displayed for the groups that do not include an active task to be executed and the other tasks of the groups are not displayed. The embodiment, however, is not limited to this. FIGS. 16A and 16B are diagrams exemplifying the expansion and display of a group. For example, it is assumed that the worker taps a representative task (+2 items) of stopping the device on the display screen illustrated in FIG. 16A. In this case, the controller 401 of the terminal 202 may expand and display all tasks included in a group including the tapped task, as illustrated in FIG. 16B. Thus, the worker may know, in detail, tasks included in work executed in the past and tasks included in work to be executed.

In another embodiment, multiple workers corresponding to multiple terminals 202 execute a single flow. For example, it is assumed that a worker enters information indicating the completion of certain work in a certain terminal 202 and that the certain terminal 202 inputs a request to update an execution state to the information processing device 201. In this case, the information processing device 201 may update the task execution state information 700, notify the completion of the certain work to another terminal 202, and synchronize the execution state of the single flow between the multiple terminals 202.

Although the embodiment is exemplified above, the embodiment is not limited to this. For example, the aforementioned operational flows are examples, and the embodiment is not limited to this. In the operational flows, the orders of the processes may be changed and the processes may be executed in the changed orders. Another process may be added to one or more of the operational flows, or a part of the processes may be omitted. For example, the order of the processes of S1101 to S1104 illustrated in FIG. 11 may be changed and the processes of S1101 to S1104 illustrated in FIG. 11 may be executed in the changed order.

In addition, the embodiment describes the example in which the terminal 202 generates, from the display information 1200, the display screen for the work support that is exemplified in FIG. 14. The embodiment, however, is not limited to this. For example, it is assumed that the information processing device 201 operates as a web server and that the terminal 202 operates as a client. In this case, the controller 301 of the information processing device 201 may generate the display screen, exemplified in FIG. 14, for the work support and causes the terminal 202 to display the generated display screen.

In addition, the aforementioned embodiment is applicable to work in various fields. For example, the aforementioned embodiment may be applied to work executed on a patient by a doctor or a nurse in a medical site.

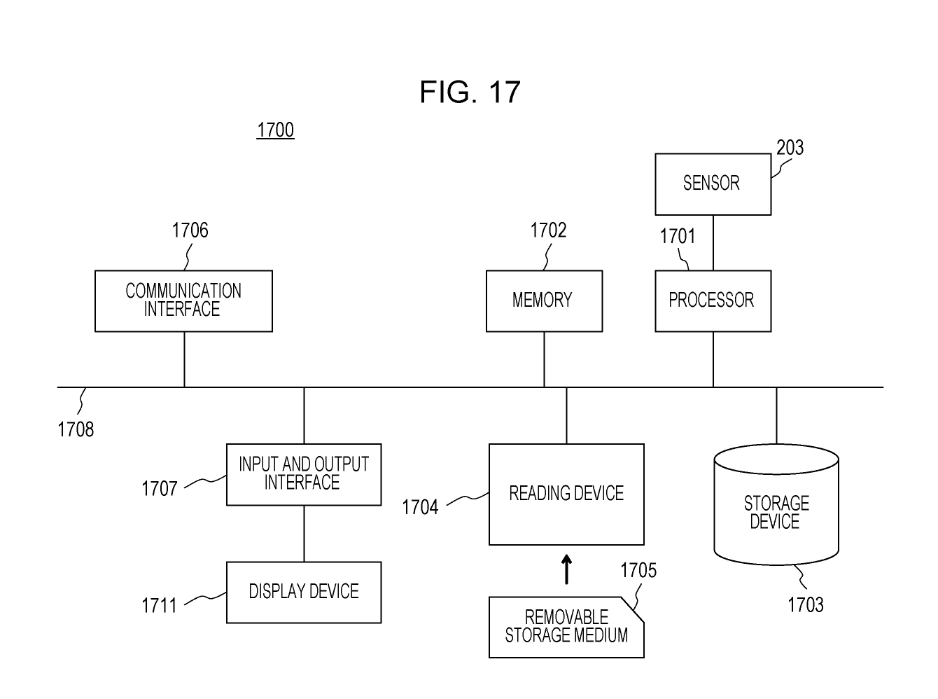

FIG. 17 is a diagram exemplifying a hardware configuration of a computer 1700 that achieves the information processing device 201 according to the embodiment and the terminal 202 according to the embodiment. The hardware configuration that is illustrated in FIG. 17 and achieves the information processing device 201 and the terminal 202 includes a processor 1701, a memory 1702, a storage device 1703, a reading device 1704, a communication interface 1706, and an input and output interface 1707, for example. In addition, the hardware configuration that is illustrated in FIG. 17 and achieves the information processing device 201 and the terminal 202 may include a display device 1711 and the sensor 203. The processor 1701, the memory 1702, the storage device 1703, the reading device 1704, the communication interface 1706, and the input and output interface 1707 are coupled to each other via a bus 1708.

The processor 1701 may be a single processor, a multiprocessor, or a multi-core processor. The processor 1701 provides a part or all of the functions of the aforementioned controller 301 by using the memory 1702 to execute a program in which the procedures for the aforementioned operational flows are described, or the processor 1701 provides a part or all of the functions of the aforementioned controller 401 by using the memory 1702 to execute a program in which the procedures for the aforementioned operational flows are described. For example, the processor 1701 of the information processing device 201 operates as the grouping unit 311 and the output unit 312 by reading and executing a program stored in the storage device 1703. In addition, the storage unit 302 or the storage unit 402 includes the memory 1702, the storage device 1703, and a removable storage medium 1705, for example. In the storage device 1703 of the information processing device 201, the task execution state information 700, the flow information 800, the real-world state information 900, and the like are stored, for example. In addition, in the storage device 1703 of the terminal 202, the task execution state information 700, the flow information 800, and the like are stored, for example.

The memory 1702 is, for example, a semiconductor memory and may include a RAM region and a ROM region. The storage device 1703 is, for example, a semiconductor memory such as a hard disk or a flash memory or an external storage device. RAM stands for Random Access Memory. ROM stands for Read Only Memory.

The reading device 1704 accesses the removable storage medium 1705 in accordance with an instruction from the processor 1701. The removable storage medium 1705 is achieved by a semiconductor device (USB memory, SD card, or the like), for example. USB stands for Universal Serial Bus.

The communication interface 1706 transmits and receives data via a network in accordance with an instruction from the processor 1701. The communication interface 1706 may be a cellular communication device to be coupled to a cellular communication network, a Wi-Fi communication device to be coupled to a Wi-Fi base station, or the like. Each of the aforementioned communication unit 303 and the aforementioned communication unit 403 is, for example, the communication interface 1706. The input and output interface 1707 may be an interface between an input device and an output device. The input device is configured to receive an instruction from a user and is a keyboard, a mouse, or the like, for example. The output device may be the display device 1711 such as a display or may be an audio device such as a speaker, for example. The display device 1711 may be implemented as a touch panel integrated with the input device. The display device 1711 is an example of the aforementioned display device 404, for example. In addition, the sensor 203 may be any of various sensors such as a GPS device, an acceleration sensor, a clock, and a vital sensor, depending on real-world information to be acquired.

The programs according to the embodiment may be provided to the information processing device 201 and the terminal 202 in one or more of the following methods.

(1) The programs are installed in the storage device 1703 in advance.

(2) The programs are provided from the removable storage medium 1705.

(3) The programs are provided from a server such as a program server.

The hardware configuration of the computer 1700 that is described with reference to in FIG. 17 and achieves the information processing device 201 and the terminal 202 is an example, and the embodiment is not limited to this. For example, a part or all of the aforementioned functional sections may be implemented as hardware such as an FPGA and an SoC. FPGA stands for Field Programmable Gate Array. SoC stands for System-on-a-chip.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A work support system comprising:
an information processing device including a first processor configured to:
group a plurality of tasks included in a workflow into a plurality of groups, based on whether sensor information obtained from a value detected by a sensor satisfies a first execution requirement which is set for one or more tasks among the plurality of tasks and defines whether the one or more tasks are to be executed, and
generate display information that is to be used to display the plurality of tasks in association with the plurality of groups, to output the generated display information; and
a terminal including a second processor configured to display, on a display screen thereof, the plurality of tasks in association with the plurality of groups, based on the display information received from the information processing device.

2. The work support system of claim 1, wherein
the first processor is configured to:
group the one or more tasks into a first group to which a task to be executed immediately before the one or more tasks in the workflow belongs when the sensor information satisfies the first execution requirement set for the one or more tasks; and
group the one or more tasks into a second group different from the first group in the workflow when the sensor information does not satisfy the first execution requirement set for the one or more tasks.

3. The work support system of claim 1, wherein:
the first processor of the information processing device is configured to generate the display information including the first execution requirement, and output the generated display information to the terminal; and
the second processor of the terminal is configured to display, on the display screen thereof, the one or more tasks and the first execution requirement in association with the plurality of groups.

4. The work support system of claim 1, wherein:
the sensor information includes a current time; and
the first execution requirement is set as a condition that the current time exceeds a predetermined time.

5. The work support system of claim 1, wherein:
the second processor of the terminal is configured to notify, at a predetermined timing, a current position of the terminal to the information processing device; and
the first execution requirement is set as a condition that the current position of the terminal is within a predetermined region.

6. The work support system of claim 1, wherein:
the first processor of the information processing device is configured to, in a case where a second execution requirement is set for a first task of the plurality of tasks, group the first task and a second task to be executed immediately after the first task, into different groups, respectively.

7. An apparatus comprising:
a memory; and
a processor coupled to the memory and configured to:
group a plurality of tasks included in a workflow into a plurality of groups, based on whether sensor information obtained from a value detected by a sensor satisfies an execution requirement which is set for one or more tasks among the plurality of tasks and defines whether the one or more tasks are to be executed, and
generate display information that is to be used to display the plurality of tasks in association with the plurality of groups, to output the generated display information.

8. A method performed by a system including an information processing device and a terminal, the method comprising:
causing the information processing device to:
group a plurality of tasks included in a workflow into a plurality of groups, based on whether sensor information obtained from a value detected by a sensor satisfies an execution requirement which is set for one or more tasks among the plurality of tasks and defines whether the one or more tasks are to be executed, and
generate display information that is to be used to display the plurality of tasks in association with the plurality of groups, to output the generated display information; and
causing the terminal to display, on a display screen thereof, the plurality of tasks in association with the plurality of groups, based on the display information received from the information processing device.
